(19) United States
(12) Patent Application Publication
(10) Pub. No.: US 2011/0276386 A1
(43) Pub. Date: Nov. 10, 2011

(54) SYSTEM AND METHODS FOR MOBILE DEVICE LOCATION BASED SERVICES

(76) Inventor: Stephen M. Deemer, Hawthorn Woods, IL (US)

(21) Appl. No.: 13/101,016

(22) Filed: May 4, 2011

Related U.S. Application Data
(60) Provisional application No. 61/331,043, filed on May 4, 2010.

(51) Int. Cl. G06Q 30/00

(52) U.S. Cl. 705/14.39; 705/14.1

(57) ABSTRACT

The present invention is directed to a discount service including a system and methods for delivering incentives to a mobile device while the mobile device is in close proximity to a merchant outlet. The presence of a mobile device is detected by receiving communication transmitted from the mobile device to a transmission tower using low wattage receivers placed at or near a merchant outlet. Incentives such as discount coupons and other promotions are sent to the mobile device in the form of an email message, text message, and/or voice message. The incentive may then be redeemed at the merchant outlet.

The present application claims priority to U.S. Provisional Patent Application No. 61/331,043 filed May 4, 2010.

### FIELD OF THE INVENTION

The present invention relates generally to mobile communication systems and more particularly to locating a mobile device for the delivery of incentives such as discount coupons or other promotions based on the location of the mobile device in proximity to a merchant outlet.

### BACKGROUND OF THE INVENTION

Incentives such as discount coupons or other promotions have been used for centuries by merchants to offer reduced prices of various goods and services. Discount coupons or other promotions are often widely distributed through mail, magazines, and newspapers. However, there are significant costs such as paper and printing. To reduce costs, merchants have turned to the Internet to provide coupons and communicate promotions. In addition, merchants send incentives electronically to mobile devices such as cell phones or personal data assistants (PDAs).

In order to send incentives electronically to mobile devices, the location of the mobile device must be known. Current methods for locating or positioning a mobile device within close proximity to a store require the consumer to actively engage applications on their mobile device such that the current location of the mobile device can be determined.

The two leading methods used in determining the location of a mobile device are the Global Positioning System (GPS) method and triangulation method. The GPS method is a satellite-based system. Satellites continually broadcast information about their locations, and receivers receive the broadcast information. The receivers then perform a calculation on the received location information to determine the point on Earth where the device is located. The triangulation method determines the location of the nearest cell towers. This is usually accomplished by determining the identifiers of the cellular tower locations. These locations are then triangulated to determine a point on Earth where the device is located. However, both methods have significant shortcomings, the least of which is the inability to consistently access the signals from these sources to accurately identify the position of the mobile device.

It would be advantageous for merchants to have assistance in identifying the position of a mobile device in order to communicate incentive offers such as discount coupons and other promotions when the mobile device is in close proximity to the merchant outlet.

### SUMMARY OF THE INVENTION

The present invention is directed to a system and methods for delivering incentive offers to a mobile device when the mobile device is in close proximity to a merchant outlet, referred to herein generally as “discount service”. The term “mobile device” includes any wireless communication device such as a cell phone, personal digital assistant (PDA), pager, tablet, and smartphone. The owner or person with possession of a mobile device that subscribes to the discount service is referred to herein as a “subscriber”. The term “merchant outlet” includes any fixed location that offers goods or services, for example, a store, boutique, or kiosk.

The presence of a mobile device is detected by receiving radio frequency (RF) signals transmitted from the mobile device using low wattage receivers or detection devices placed at or near a merchant outlet. Incentive offers such as discount coupons and/or promotions are sent to the mobile device in an email message, text message, and/or voice message. However, any method is contemplated to communicate the incentive offer such as link to a website or icon for selection to present the incentive offer. The incentive offer may then be redeemed at the merchant outlet. Since there is no subscriber initiated action required, other than subscribing to the discount service, the incentive offers appear to arrive at the mobile device spontaneously.

The present invention provides merchants the ability to offer incentives to consumers located in close proximity to the merchant outlet thereby enticing the consumer to enter the merchant outlet. The present invention involves installing detection devices at merchant outlets to detect mobile devices. A detection device detects the presence of a subscriber through their mobile device. The detection device obtains a mobile device identifier such as an International Mobile Equipment Identifier (IMEI) or proprietary equipment identifier transmitted by the mobile device to the transmission tower of a wireless network of a service provider.

A mobile device identifier and a location code identifying the detection device are sent to a server over the Internet and compared to a database. The mobile device identifier is compared to registered identifiers for mobile devices registered for the discount service. The registered identifiers associated with subscribers are stored in a database located on a server. Those mobile devices that are registered for the discount service are eligible for incentive offers.

A server searches the database for merchant outlets within close proximity to the current location of the mobile device based on the location code of the detection device. The database includes stored location codes of detection devices and corresponding incentive offers, which are updated periodically. The location code of the detection device sent with the mobile device identifier is compared to the stored location codes for a match. Upon determining a match, incentive offers corresponding to the location code are provided to the mobile device. The server initiates the transmission of a pre-recorded voice message, email message, and/or text message to the mobile device with the corresponding incentive offer such as a discount coupon and/or other promotion.

After products or services are selected for purchase based on the incentive offer received, the subscriber redeems the incentive offer. The incentive offer may include a scannable bar code or promotion code. For example, an email message may include a bar code that may be scanned directly off the mobile device, thus entering the incentive offer into the payment system. An alternative is that a promotion code contained in the email message may be manually entered from the display of the mobile device into the payment system of the merchant outlet. A voice message or text message may include information such as a keyword, phrase, or code to be communicated to a salesperson at the merchant outlet that enters the keyword, phrase or code into the payment system. The payment system then credits the sale transaction with the appropriate discount coupon or promotion of the incentive offer.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will be described in conjunction with the appended drawings provided to illustrate and not to the limit the invention, where like designations denote like elements, and in which:

FIG. 1 illustrates one embodiment of a communication network that may be used to implement the methods according to the present invention;

FIG. 2 illustrates a block diagram of one embodiment of a detection device according to the present invention; and

FIG. 3 illustrates a process flow diagram of the discount service according to one embodiment of the present invention.

### DESCRIPTION OF PREFERRED EMBODIMENTS

For purposes of this application, it is contemplated that a subscriber has registered for the discount service, a merchant outlet participates in the discount service, and a detection device is positioned at the participating merchant outlet.

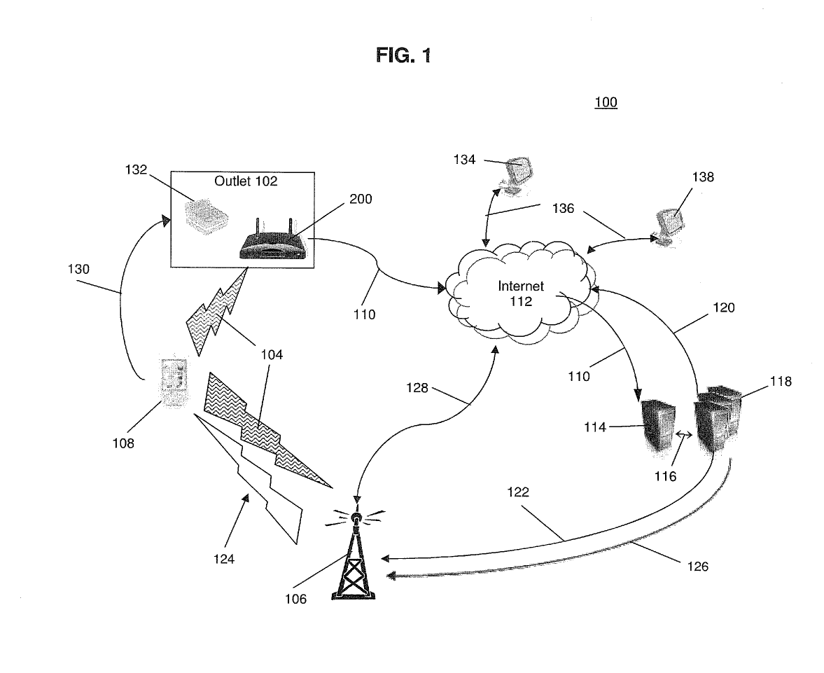

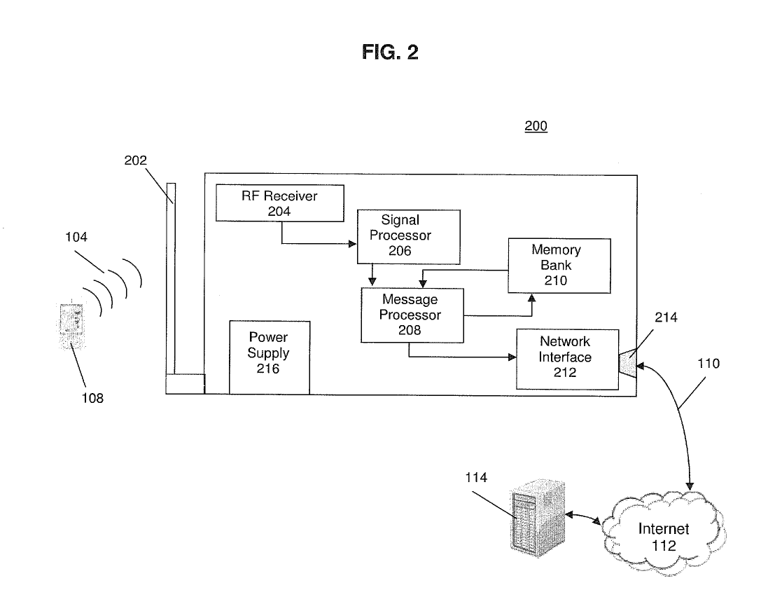

FIG. 1 illustrates one embodiment of a communication network 100 that may be used to implement the methods according to the present invention. A merchant outlet 102 includes a low wattage receiver referred to herein as a detection device 200, described in further detail with respect to FIG. 2. The detection device 200 includes a location code that is unique to each detection device 200.

The detection device 200 receives communication between a mobile device 108 and a transmission tower 106, otherwise known as a cell tower or base station. Communication between a mobile device 108 and a transmission tower 106 is referred to herein as mobile device communication 104. Mobile device communication 104 is radio frequency (RF) signals supported by a wireless network such as Code Division Multiple Access (CDMA), Time Division Multiple Access (TDMA), Frequency Division Multiple Access (FDMA), Global System for Mobile (GSM) and Personal Communication Service (PCS). It is also contemplated that wireless networks may include any satellite communication system and local area communication systems such as WiFi and WiMax.

The detection device 200 obtains a mobile device identifier from within the mobile device communication 104 transmitted by the mobile device 108. A mobile device identifier may be anything that distinguishes a particular mobile device 108, such as an International Mobile Equipment Identifier (IMEI) or proprietary equipment identifier. The IMEI is a unique code assigned to a mobile device 108 by the equipment manufacturer to differentiate the mobile device 108 from all other mobile devices within the wireless network. In one embodiment, the detection device 200 obtains the mobile device identifier by demodulating the mobile device communication 104 to extract the International Mobile Equipment Identifier (iMEI). In another embodiment, the detection device 200 may compare the IMEI with data stored locally in the detection device 200 to confirm the mobile device 108 belongs to a wireless network in order to retrieve a proprietary equipment identifier from the locally stored data for the mobile device 108.

The detection device 200 formulates an Internet compatible message 110. The Internet compatible message 110 contains the mobile device identifier and the location code assigned to the detection device 200. In one embodiment, the detection device 200 is connected to the Internet 112 and an Internet compatible message 110 is sent over the Internet 112 to a web enabled application server 114. The web enabled application server 114 processes the Internet compatible message 110 in order to transmit a discount message 120.

The proprietary network 116 includes one or more servers, such as a web enabled application server 114 and one or more secondary servers 118, although it is contemplated that that web enabled application server 114 may also function as one or more of the secondary servers 118. It is also contemplated that the web enabled application server 114 and one or more secondary servers 118 may be a single server or multiple interconnected servers and mass storage devices distributed on the proprietary network 116.

The database may be stored on the web enabled application server 114 or one or more secondary servers 118. The database stores subscriber data and merchant data. For purposes of this application, the term “database” may refer to a single database or multiple databases that are interconnected and distributed on the proprietary network 116. Subscriber data includes the mobile device identifier such as IMEI or proprietary equipment identifier, mobile device information such as an email address and phone number associated with the mobile device. Merchant data includes name and location of the merchant outlet, detection device location code and the incentive offers. Incentive offers include discount coupons and/or promotions, which may be updated periodically. Furthermore, the incentive offers may be merchant specific and/or location specific.

The web enabled application server 114 and one or more secondary servers 118 may also provide various services according to the present invention, for example, distribute emails, host web access, provide text messaging, database services, email services, voice messaging telephony hardware and load balancing, to name a few.

The web enabled application server 114 compares the mobile device identifier of the mobile device 108 to a database. The database includes the mobile device identifiers of mobile devices 108 registered for the discount service and eligible for incentive offers. The web enabled application server 114 determines if any incentive offer is available for merchant outlets based on the location code of the detection device 200, which is placed in or near a merchant outlet 102. If incentive offer such as a discount coupon or other promotion is available, the web enabled application server 114 determines the delivery options available for the incentive offer and further the delivery options available to the mobile device 108. Delivery options may include, for example, email message, voice message, and text message. The web enabled application server 114 initiates the transmission of a pre-recorded voice message, email message, and/or text message to the mobile device 108 with the corresponding incentive offer such as a discount coupon and/or other promotion.

Although the incentive offer of present invention is discussed herein as being communicated through an email message, text message, and voice message, any method is contemplated to communicate the incentive offer such as link to a website or icon for selection to present the incentive offer.

In the embodiment where the delivery option is an email, the web enabled application server 114 invokes a process on the proprietary network 116 to send an email message to the mobile device 108. The discount message 120 in the form of an email message is generated by the web enabled application server 114 or a secondary server 118, for example an email server, running on the proprietary network 116. The web enabled application server 114 or email secondary server 118 generates and sends a discount message 120 in the form of an email message over the Internet 112. The email discount message 120 is routed over the Internet 112 through the network provider Internet connection 128. The email message is sent to the transmission tower 106 and to the mobile device 108 through transmission frequencies 124. The subscriber accesses his or her email account from the mobile device 108 to view the email discount message 120 containing the incentive offer. In one embodiment, the mobile device 108 displays a code such as bar code or promotion code contained within the email discount message 120. The bar code may be communicated 130 to a salesperson at the merchant outlet 102 that scans or enters the bar code or promotion code into the payment system 132. The bar code may be scanned from the display of the mobile device 108 similar to scanning a printed coupon. Alternatively, in another embodiment, the promotion code contained in the discount email message 120 may be manually entered from the display of the mobile device 108 into the payment system 132 of the merchant outlet 102. The payment system 132 credits the sale transaction with the appropriate discount coupon or promotion based on the scanned bar code or entered promotion code.

In the embodiment where the delivery option is a text, the web enabled application server 114 invokes a process on the proprietary network 116 to send a text message to the mobile device 108. The discount message 120 in the form of a text message is generated by the web enabled application server 114 or a secondary server 118, for example a server that can generate a text message, running on the proprietary network 116. The web enabled application server 114 or text secondary server 118 generates and sends a discount message 120 in the form of a text message. The text message is sent 122 to the transmission tower 106, which sends the text message through transmission frequencies 124 to the mobile device 108. The mobile device 108 receives the text message containing the incentive offer. The discount coupon or promotion contained in the text message is communicated 130 to a salesperson at the merchant outlet 102 who scans or enters the bar code or promotion code into the payment system 132. The payment system 132 then credits the sale transaction with the appropriate discount coupon or promotion.

In the embodiment where the delivery option is a voice message, the web enabled application server 114 invokes a process on the proprietary network 116 to send a voice message to the mobile device 108. A voice message request is generated by the web enabled application server 114 or a secondary server 118. A pre-recorded voice message that includes an incentive offer is selected. Telephony hardware that may be a part of the web enabled application server 114 or secondary server 118 dials, or calls, the mobile device 108. The pre-recorded voice message is transmitted 126 to the transmission tower 106 and to the mobile device 108. After the call is answered by the mobile device 108, the pre-recorded voice message is sent through transmission frequencies 124 and played. The voice message may include information such as a keyword, phrase, or code to be communicated 130 to a salesperson at the merchant outlet 102 who scans or enters the bar code or promotion code into the payment system 132. The payment system 132 then credits the sale transaction with the appropriate discount coupon or promotion.

It is contemplated that a subscriber website 134 may be hosted on the web enabled application server 114 or one or more secondary servers 118. The subscriber website 134 is accessible to subscribers over the Internet 112 through an Internet connection 136. The subscriber website 134 provides the ability for subscribers to participate in the discount service, such as through registration. In addition, the subscriber website 134 may allow the subscriber to manage his or her account, such as update profile information, track redeemed incentive offers, and manage preferences including the ability to subscribe and unsubscribe from the discount service. Information related to the subscriber website 134 is communicated to the web enabled application server 114. It is also contemplated that an application running on the mobile device 108 may provide the same functionality as the subscriber website 134.

It is contemplated that a merchant website 138 may be hosted on the web enabled application server 114 or one or more secondary servers 118. The merchant website 138 is accessible to merchants over the Internet 112 through an Internet connection 136. The merchant website 138 provides the ability for merchants to participate in the discount service, such as through registration. In addition, the merchant website 138 may allow the merchant to manage his or her account, such as update profile information, track and update incentive offers, and manage preferences including the ability to subscribe and unsubscribe from the discount service as well as maintain the particulars related to the detection device. Information related to the merchant website 138 is communicated to the web enabled application server 114.

FIG. 2 illustrates a block diagram of one embodiment of a detection device 200 according to the present invention. The detection device 200 includes a variety of components including an antenna 202, a radio frequency (RF) receiver 204, a signal processor 206, a message processor 208, a memory bank 210, a network interface 212, an input/output port 214 such as an Ethernet jack, and a power supply 216. It is contemplated that two or more of the components of the detection device 200 may be integrated. For example, the RF receiver 204 and signal processor 206 may be separate components or integrated into a single component.

The antenna 202 is configurable to be optimal for receiving mobile device communication 104 between mobile devices 108 and the transmission tower 106 or base station (see FIG. 1). Mobile device communication 104 is in the form of radio frequency (RF) signals supported by a wireless network such as Code Division Multiple Access (CDMA), Time Division Multiple Access (TDMA), Frequency Division Multiple Access (FDMA), Global System for Mobile (GSM) and Personal Communication Service (PCS) as well as wireless networks that may include any satellite communication system and local area communication systems such as WiFi and WiMax.

The RF receiver 204 receives mobile device communication 104 of a mobile device 108 received by the antenna 202. RF frequency signals are passed to the signal processor 206, which demodulates the RF frequency signal into a digital data stream. The digital data stream is passed to the message processor 208 that interrogates the digital data stream to obtain a mobile device identifier such as an International Mobile Equipment Identifier (IMEI) or proprietary equipment identifier to uniquely identify the mobile device 108. Once the mobile device identifier is obtained, the message processor 208 searches the memory bank 210 for the mobile device identifier stored therein.

If the mobile device identifier is not found, the message processor 208 saves the mobile device identifier in the memory bank 210 as well as an associated timestamp including a configurable delay. The timestamp including configurable delay may be the current time, plus the configurable delay, expressed in minutes. However, any expression is contemplated such as seconds, and milliseconds. Next, the message processor 208 generates an Internet compatible message 110. The Internet compatible message 110 includes the mobile device identifier such as IMEI number or proprietary equipment identifier and the location code assigned to the detection device 200. The message processor 208 passes the Internet compatible message 110 to the network interface 212 for transmission through the input/output port 214 such as an Ethernet jack. The Internet compatible message 110 passes through the Internet 112 and to the web enabled application server 114.

If the mobile device identifier is found in the memory bank 210, the message processor 208 compares the timestamp including configurable delay saved with the mobile device identifier in the memory bank 210 to the current time. If the timestamp including configurable delay saved with the mobile device identifier has not expired—the time period has not elapsed since the last incentive offer was sent—, the mobile device 108 is ignored and no incentive offer is sent. This process is intended to limit the number of emails, text messages and/or voice messages sent to a particular mobile device 108 within a configurable time period, for example, one incentive offer per merchant per day, but not limited to one incentive offer per day. If the timestamp has expired—the time period has elapsed since the last incentive offer was sent—, the message processor 208 updates the memory bank 210 with the mobile device identifier and a new timestamp including configurable delay. An Internet compatible message 110 is generated and the message processor 208 passes the Internet compatible message 110 to the network interface 212 for transmission through the input/output port 214 to the Internet 112 and onto the web enabled application server 114.

In another embodiment, a process initiated by either the detection device 200 or a web enabled application server 114 updates the memory bank 210 with the mobile device identifier of current subscribers to the discount service. In this embodiment, the message processor 208 generates an Internet compatible message 110 for the mobile device identifier of current subscribers stored in the memory bank 210.

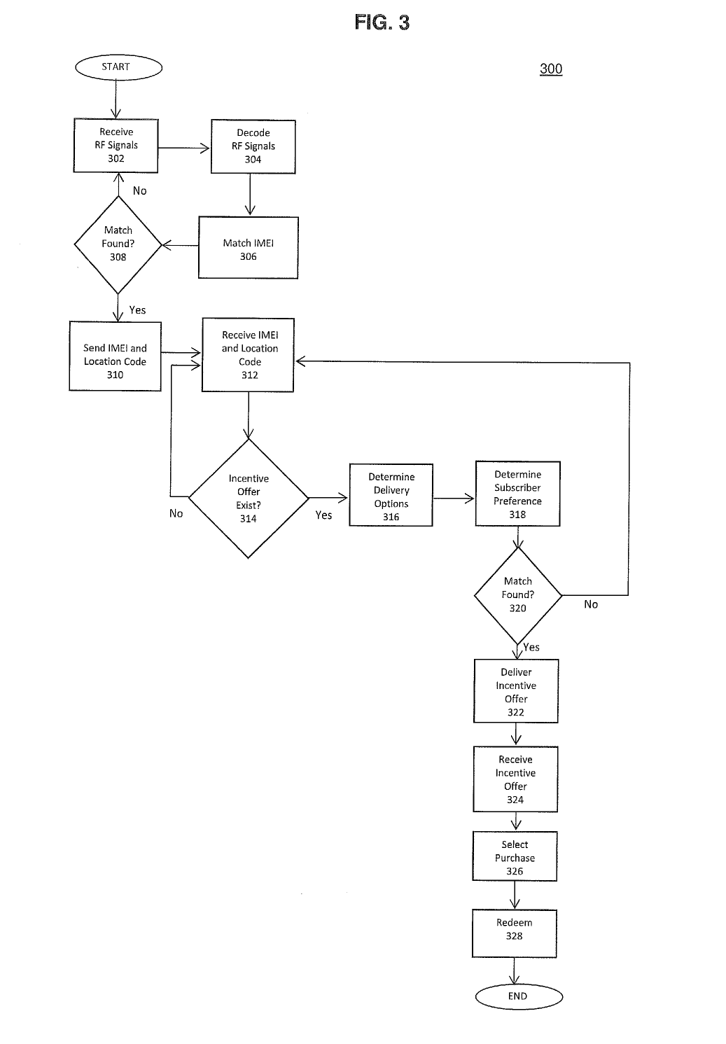

FIG. 3 illustrates a process flow diagram 300 of the discount service according to one embodiment of the present invention. As shown in step 302, the detection device receives radio frequency (RF) signals from mobile devices in close proximity to the detection device. The detection device decodes the received radio frequency (RF) signals into a digital data stream at step 304. The digital data stream contains the mobile device IMEI, however any mobile device identifier is contemplated. In this embodiment, the IMEI of the mobile device is compared to the IMEIs of subscribers stored in the memory bank of the detection device at step 306. If no match is found at step 308, the detection device returns to receiving radio frequency (RF) signals from mobile devices in close proximity to the detection device at step 302. If a match is found at step 308, the detection device sends the IMEI and the location code of the detection device to a web enabled application server at step 310. At step 312, the IMEI of the mobile device and the location code of the detection device are received by the web enabled application server. At step 314, the web enabled application server determines if incentive offers exist in the database based on the location code of the detection device. If no incentive offer is found at step 314, the web enabled application server returns to receiving the IMEI of the mobile device and the location code of the detection device at step 312. If one or more incentive offers is found at step 314, the delivery options for the one or more incentive offers are determined at step 316. At step 318, the preferred delivery options of the subscriber are determined. The delivery options of the incentive offer at step 316 and the subscriber preferred delivery options at step 318 are compared at step 320. If there is no match between the incentive delivery options and the subscriber preferred delivery options, the web enabled application server returns to receiving the IMEI of the mobile device and the location code of the detection device at step 312. If a match is found at step 320, the incentive offer is delivered at step 322. The incentive offer may be delivered through an email message, a pre-recorded voice message, and/or a text message sent to the mobile device of the subscriber. The subscriber receives the incentive offer on his or her mobile device at step 324. Products or services are selected for purchase at step 326 based on the incentive offer received at step 324. The subscriber presents the incentive offer to redeem the discount at step 328.

While this disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. A method for providing a discount service based on a location of a mobile device of a subscriber, comprising the steps of:
positioning a detection device at or near a merchant outlet, wherein the detection device includes a location code;
receiving signals by the detection device;
demodulating the signals to obtain a mobile device identifier;
sending the location code and mobile device identifier to a server;
accessing a database including subscriber data and merchant data;
comparing the location code to merchant data to obtain an incentive offer of a merchant;
reviewing the mobile device identifier and subscriber data to determine a delivery option of the mobile device; and
sending the incentive offer to the mobile device according to at least one delivery option of said reviewing step.

2. The method according to claim 1, wherein the subscriber data includes a mobile device identifier.

3. The method according to claim 2, wherein the mobile device identifier is an International Mobile Equipment Identifier.

4. The method according to claim 1, wherein the subscriber data includes at least one selected from the group of an email address and a phone number associated with the mobile device.

5. The method according to claim 1, wherein the merchant data includes at least one selected from the group of merchant outlet name, merchant outlet location, and detection device location code.

6. The method according to claim 1, wherein the incentive offer is a discount coupon.

7. The method according to claim 1, wherein the delivery option is at least one selected from the group of email message, text message, and voice message.

8. The method according to claim 1, wherein the subscriber registers for the discount service through a website in communication with a server.

9. The method according to claim 1, wherein the merchant registers for the discount service through a website in communication with a server.

10. The method according to claim 1, wherein the database is stored on a web enabled application server.

11. The method according to claim 1, wherein the detection device comprises a receiver, a signal processor, a message processor, a memory bank, and a network interface.

12. The method according to claim 1, wherein the detection device is connected to a network capable of communicating with the Internet.

13. The method according to claim 1, wherein the signals are radio frequency (RF) signals between the mobile device and a transmission tower.

14. The method according to claim 6, wherein the discount coupon is in the form of a bar code.

15. A system for providing a discount service based on a location of a mobile device of a subscriber, comprising:
a detection device, wherein said detection device includes a receiver, a signal processor, a message processor, a memory bank, and a network interface;
said receiver receives signals communicated between the mobile device and a transmission tower of a wireless network, wherein the signals are demodulated into a digital data stream by said signal processor and said message processor interrogates the digital data stream for a mobile device identifier,
said message processor generates an Internet compatible message, wherein the Internet compatible message includes the mobile device identifier and the Internet compatible message is sent to said network interface,
a server, wherein said server receives the Internet compatible message transmitted from said network interface; and
a database, wherein said server reviews said database to determine an incentive offer and said server generates a communication of the incentive offer to the mobile device.

16. The system according to claim 15, wherein the mobile device identifier is an International Mobile Equipment Identifier.

17. The system according to claim 15, wherein the communication of the incentive offer is at least one selected from the group of email message, text message, and pre-recorded voice message.

18. The system according to claim 15, wherein said server determines the delivery options for the incentive offer and the delivery options of the mobile device and generates the communication of the incentive offer based on a match between the delivery options for the incentive offer and the delivery options of the mobile device.

19. The system according to claim 15, wherein said memory bank includes a timestamp including a configurable delay that is compared with the current time to determine if mobile device identifier has expired.

20. The system according to claim 19, wherein said server does not generate the communication of the incentive offer when the timestamp including the configurable delay has not expired.
